(19) United States
(12) Patent Application Publication
(10) Pub. No.: US 2021/0055827 A1
(43) Pub. Date: Feb. 25, 2021

(54) USER VERIFICATION METHOD AND MOBILE DEVICE

(71) Applicant: HTC Corporation, Taoyuan City (TW)

(72) Inventors: Cheng-Lin Huang, Taoyuan City (TW); Chin-Yu Wang, Taoyuan City (TW); Shang-Jing Wu, Taoyuan City (TW)

(73) Assignee: No. 23, Xinghua Road, Taoyuan District,, Taoyuan City (TW)

(21) Appl. No.: 16/734,381

(22) Filed: Jan. 5, 2020

(30) Foreign Application Priority Data
Aug. 22, 2019 (TW) 108130060

(51) Int. Cl. G06F 3/042; G06F 21/31; G06F 21/55; G06F 21/46; G06K 9/00; H04W 12/00

(52) U.S. Cl. CPC G06F 3/0428; G06F 21/31; G06F 21/554; G06F 2221/2117; G06K 9/00355; H04W 12/002; G06F 21/46

(57) ABSTRACT

A user verification method for a mobile device having an edge sensor and a mobile device implementing the method are provided. The method includes detecting, by the edge sensor, a squeezing action performed on the mobile device in response to determining that a specific event occurs, and performing a verification procedure according to the squeezing action to obtain a user verification result; in response to the user verification result being successful, performing a first operation; in response to the user verification result being failed, performing a second operation. Furthermore, the verification procedure includes retrieving verification data corresponding to the specific event from a database; and determining whether the user verification result is successful or failed by comparing the verification data with a pattern of the squeezing action.

### CROSS-REFERENCE TO RELATED APPLICATION

This application claims the priority benefit of Taiwan application serial no. 108130060, filed on Aug. 22, 2019. The entirety of the above-mentioned patent application is hereby incorporated by reference herein and made a part of this specification.

### BACKGROUND

### Field of the Invention

The invention relates to a verification method, and more particularly, to a user verification method for a mobile device having an edge sensor and a mobile device using the method.

### Description of Related Art

With the security of mobile devices increasingly being valued in the market, various applications for anti hacking system, anti data leakage and user security certification have been developed. However, in fact, most of end users are still using a fingerprint identification in combination with a password lock or a pattern lock as two mechanisms for user security identification. Although the fingerprint identification has the advantages of high precision and low risk, hackers can still steal or arbitrarily use all applications on the mobile device by learning or stealing a user default password. Therefore, the traditional security mechanism is still vulnerable in many ways.

At present, the use of applications and mobile devices in the market is mainly based on the fingerprint identification in combination with the password lock. Because one of the disadvantages of the password lock is that the password can be easily cracked by hackers or the device can be obtained easily by acquaintances, the password needs to be updated regularly for security reasons. Also, news regarding the latest iris recognition technology still being cracked by hackers can still be heard from time to time. Therefore, the existing technology is still unable to completely overcome the security vulnerability.

### SUMMARY

The invention provides a plurality of verification methods and a plurality of mobile devices, which are capable of performing a verification procedure by detecting a squeezing action performed on the mobile when a specific event occurs, so as to determine whether to lock the mobile device according to a result of the verification procedure.

An embodiment of the invention provides a user verification method for a mobile device having an edge sensor. The method includes detecting, by the edge sensor, a squeezing action performed on the mobile device in response to determining that a specific event occurs, and performing a verification procedure according to the squeezing action to obtain a user verification result; in response to the user verification result being successful, performing a first operation; in response to the user verification result being failed, performing a second operation. Here, the second operation includes locking the mobile device. Furthermore, the verification procedure includes retrieving verification data corresponding to the specific event from a database; and determining whether the user verification result is successful or failed by comparing the verification data with a pattern of the squeezing action.

An embodiment of the invention provides a user verification method for a mobile device having a plurality of edge sensors. The method includes detecting, by the edge detectors, a squeezing action applied to the mobile device in response to determining that a specific event occurs so as to obtain a plurality of squeezing strength curves respectively corresponding to the edge detectors, wherein each of the squeezing strength curves records a plurality of squeezing strength values of the squeezing action sequentially detected at different time points by the respective edge detector to which each of the squeezing strength curves belongs; obtaining a plurality of squeezing strength codes respectively corresponding to the edge detectors according to a predetermined period corresponding to the specific event and the squeezing strength curves; performing a verification procedure according to the squeezing strength codes to obtain a user verification result; in response to the user verification result being successful, performing a first operation; in response to the user verification result being failed, performing a second operation. Here, the second operation includes locking the mobile device. Furthermore, the verification procedure includes retrieving a password corresponding to the specific event from a database; and determining whether the user verification result is successful or failed by comparing the password with the squeezing strength codes.

An embodiment of the invention provides a mobile device, which includes a body, a processor, an edge detector and a storage device. The edge detector is disposed on two sides of the body. The processor is disposed in the body and coupled to the edge detectors and the storage device, The processor is configured to instruct the edge detector to detect a squeezing action applied to the body in response to determining that a specific event occurs, and the processor is configured to perform a verification procedure according to the squeezing action to obtain a user verification result. In response to the user verification result being successful, the processor is configured to perform a first operation. In response to the user verification result being failed, the processor is configured to perform a second operation. The verification procedure includes retrieving verification data corresponding to the specific event from a database in the storage device by the processor; and determining whether the user verification result is successful or failed by comparing the verification data with a pattern of the squeezing action by the processor.

An embodiment of the invention provides a mobile device, which includes a body, a processor, a plurality of edge detectors and a storage device. The edge detectors are evenly disposed on two sides of the body. The processor is disposed in the body and coupled to the edge detectors and the storage device. The processor is configured to instruct the edge detectors to detect a squeezing action applied to the mobile device in response to determining that a specific event occurs so as to obtain a plurality of squeezing strength curves respectively corresponding to the edge detectors. Here, each of the squeezing strength curves records a plurality of squeezing strength values of the squeezing action sequentially detected at different time points by the respective edge detector to which each of the squeezing strength curves belongs. Then, the processor is configured to obtain a plurality of squeezing strength codes respectively corresponding to the edge detectors according to a predetermined period corresponding to the specific event and the squeezing strength curves. The processor is configured to perform a verification procedure according to the squeezing strength codes to obtain a user verification result. In response to the user verification result being successful, the processor is configured to perform a first operation. In response to the user verification result being failed, the processor is configured to perform a second operation. Here, the second operation includes locking the mobile device. The verification procedure includes retrieving a password for identifying corresponding to the specific event from a database in the storage device by the processor; and determining whether the user verification result is successful or failed by comparing the password with the squeezing strength codes by the processor.

Based on the above, the user verification method and the mobile device provided in the embodiments of the invention can detect, by the edge sensor, the squeezing action performed on the mobile device in response to that the specific event occurs, and compares the squeezing strength value or the squeezing characteristic quantity of the squeezing action with the verification data so as to determine whether the user verification result is successful or failed. In addition, the squeezing strength codes respectively corresponding to the edge detectors may also be obtained from the detected squeezing action, so as to determine whether the user verification result is successful or failed by comparing the password corresponding to the event with the squeezing strength codes. Finally, whether to perform the first operation or the second operation corresponding to the specific event may be determined according to the user verification result.

To make the aforementioned more comprehensible, several embodiments accompanied with drawings are described in detail as follows.

### BRIEF DESCRIPTION OF THE DRAWINGS

FIG. 1 is a schematic diagram illustrating a mobile device according to a first embodiment of the invention.

FIG. 2 is a schematic block diagram illustrating the mobile device according to the first embodiment of the invention.

FIG. 3 is a schematic diagram illustrating a squeezing action according to the first embodiment of the invention.

FIG. 4 is a flowchart illustrating a user verification method according to the first embodiment of the invention.

FIG. 5 is a schematic diagram illustrating a plurality of verification data corresponding to a plurality of different specific events according to the first embodiment of the invention.

FIG. 6A illustrates line charts of a plurality of squeezing strength curves respectively corresponding to a plurality of edge detectors according to the first embodiment of the invention.

FIG. 6B illustrates a line chart of a squeezing strength curve of the squeezing action detected by one edge detector according to the first embodiment of the invention.

FIG. 7 is a flowchart illustrating a user verification method according to a second embodiment of the invention.

FIG. 8A is a schematic diagram illustrating how the squeezing strength values are converted into the squeezing strength codes according to the second embodiment of the invention.

FIG. 8B is a schematic diagram illustrating the converted squeezing strength codes respectively corresponding to a plurality of edge detectors according to the second embodiment of the invention.

FIG. 9 is a schematic diagram illustrating a plurality of passwords corresponding to a plurality of different specific events according to the second embodiment of the invention.

### DESCRIPTION OF THE EMBODIMENTS

The user verification method proposed by the invention utilizes an edge sensor disposed on a mobile device to perform a security verification for users. Habit and strength of a user holding the mobile device when one or more specific events occur can be recorded by detecting a squeezing action of the user through the edge detector. Accordingly, one or more security data respectively corresponding to said one or more specific events can be obtained for verification. In this way, later, when a specific event occurs, the detected squeezing action can be verified by the security data corresponding to that specific event to verify whether a user currently holding the mobile device is a specific user.

### First Embodiment

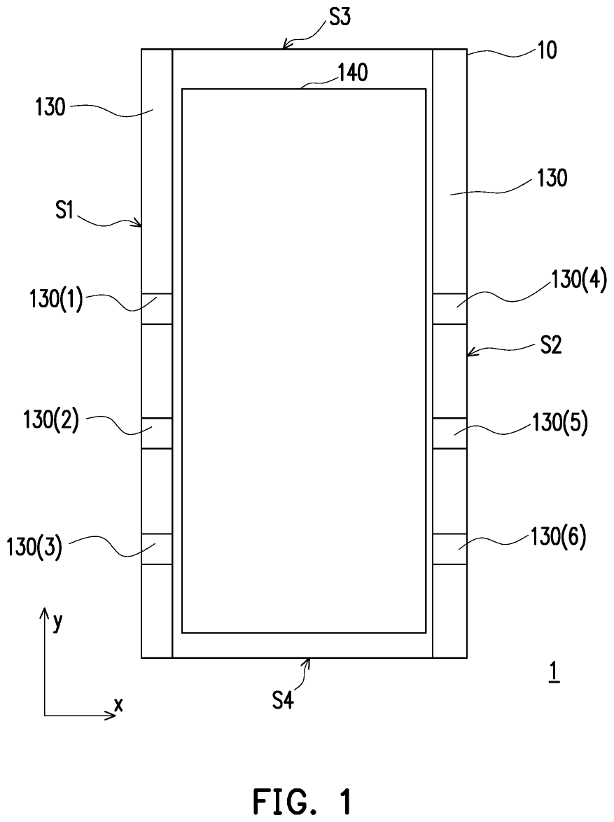

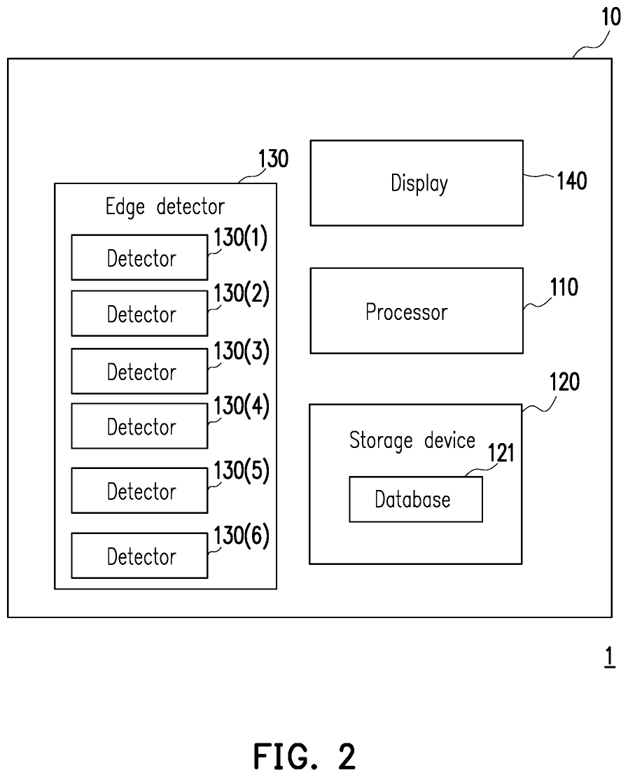

FIG. 1 is a schematic diagram illustrating a mobile device according to a first embodiment of the invention. FIG. 2 is a schematic block diagram illustrating the mobile device according to the first embodiment of the invention. Referring to FIG. 1 and FIG. 2 together, in this embodiment, a mobile device 1 includes a body 10, a display 140, an edge detector 130, a processor 110 and a storage device 120. The processor 110 and the storage device 120 are disposed in the body 10. The display 140 is disposed on the body 10 and configured to display information content for the user. The edge detector 130 can be disposed on the left and right sides (e.g., a left side S1 and/or a right side S2) of the body 10. In other embodiments, the edge detector may also be disposed on an upper side S3 and/or a lower side S4 of the body 10. The edge detector 130 can include a plurality of detectors, which are distributed (e.g., evenly distributed) on the two sides S1 and S2 of the edge detector 130. As shown by FIG. 1, for the edge detector 130 having six detectors (first to sixth detectors 130(1) to 130(6)), three detectors are disposed on each side. For example, three detectors 130(1) to 130(3) are disposed on the left side S1; three detectors 130(4) to 130(6) are disposed on the right side S2.

In this embodiment, the mobile device 1 is, for example, an electronic device such as a smart phone, a tablet computer or a smart wearable device. An application type of the electronic device 1 is not particularly limited by the invention. That is, any electronic device that can be disposed with the edge detector may be regarded as the mobile device described in this embodiment.

The processor 110 is coupled to the edge detector 130, the storage device 120 and the display 140. The processing unit 110 is a hardware having a computing capability (for example, a chip set, a processor or the like), and configured to control overall operations of the mobile device 1. In this embodiment, the processing unit 110 is, for example, a central processing unit (CPU) of single-core or multi-core, a micro-processor, other programmable microprocessors, a digital signal processor (DSP), a programmable controller, an application specific integrated circuits (ASIC), a programmable logic device (PLD) or other similar devices.

The storage device 120 may be a hard disk drive (HDD) or a non-volatile memory storage device (a nonvolatile memory module/circuit unit) in any form. The storage device 120 can store data through an instruction of the processor 110. The data storage device 120 may also store data in advance before leaving the factory. Said data includes data for managing the mobile device 1 (software or firmware), data to be exchanged with other electronic devices/mobile devices, applications, data input by the user, or other types of data, which are not particularly limited by the invention. In addition, the storage device 120 also stores a database 121, which can store/record relevant information, verification data or passwords of the specific user through an instruction of the processor 110.

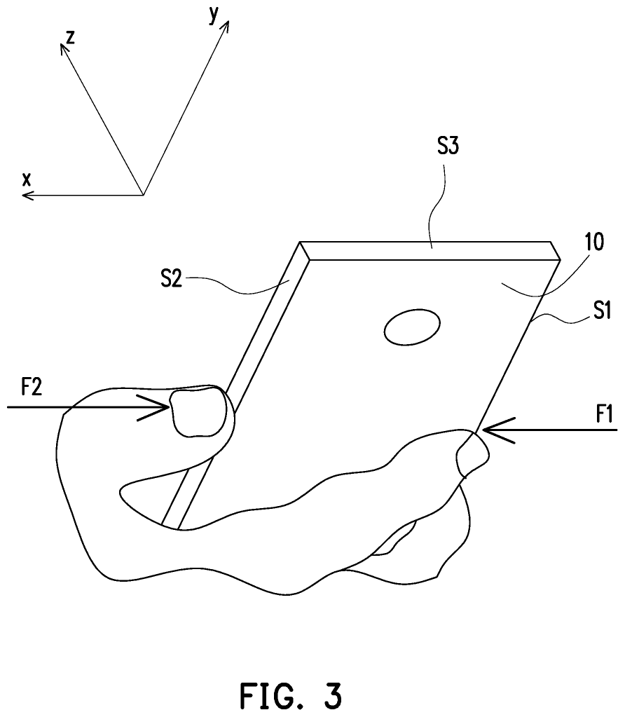

The edge sensor 130 (e.g., one of the detectors 130(1) to 130(6)) is, for example, a pressure detector, a resistance detector, a light detector, or an acoustical detector. The edge detector is configured to detect a holding action performed by the user on the mobile device 1, such as a squeezing action (which will be further described below with reference to FIG. 3). In addition, the edge detector may also be used to detect other actions, such as a touch action, a slide action, a tap action, and the like. In this embodiment, the edge detector belongs to the pressure detector, and is a balanced bridge structure composed of a varistor and mounted on both sides (e.g., the two sides S1 and S2) of an outer frame of the mobile device 1 that can be easily held by the palm of the user. When the user grips the outer frame of the mobile device to deform the mechanism (e.g., when the user performs a squeezing operation on the mobile device 1), the edge detector 130 mounted on one or both sides of the mobile device is deformed by the deformation of the outer frame. Consequently, a resistance of the varistor is changed to cause the bridge to be unbalanced such that a detection signal (detection data) output by the bridge circuit is changed accordingly. Since the amount of deformation of the edge detector 130 has a corresponding relationship with the detection data output by the bridge circuit, through such association, the processor 110 can process the detection data to obtain squeezing patterns of the squeezing action at different time points (include one or a combination of a squeezing strength value, a squeezing area, a squeezing location, a squeezing number, etc.), which can be combined into one pattern for providing further functional applications.

FIG. 3 is a schematic diagram illustrating a squeezing action according to the first embodiment of the invention, in which a squeezing strength is used as an example. Referring to FIG. 3, the user applies forces F1 and F2 with the finger or the hand to press the two sides S1 and S2 of the mobile device 1 so as to grasp/hold the mobile device 1. For example, by setting an orthogonal coordinate system on the mobile device 1 (with an x-axis direction extending from the left side S1 to the right side S2, a y-axis direction extending from the lower side S4 to the upper side S3, and a z-axis direction extending from a rear side of the mobile device to a front side, as shown in FIG. 3), a direction of the force F1 is a positive x direction, and a direction of the force F2 is a negative x direction. At this time, in response to the deformation caused by the forces F1 and F2, the edge detector 130 can detect the “squeezing action” and strengths of the forces F1 and F2.

In this embodiment, when a signal level (a voltage level/a voltage value) of the detection signal output from the edge detector 130 exceeds a squeezing threshold, the processor 110 determines that the squeezing action is being applied to the mobile device 1 i.e., a squeezing event occurs. Conversely, in another embodiment, when the signal level (the voltage level/the voltage value) of the detection signal output from the edge detector 130 does not exceed the squeezing threshold, the processor 110 determines that the squeezing action is not being applied to the mobile device 1, i.e., the squeezing event does not occur. The signal level (the voltage level/the voltage value) of the detection signal may indicate a strength of the squeezing action/the touch action (e.g., the squeezing strength value or a touch intensity value). In addition, the squeezing strength values obtained by detecting the squeezing action over time can form a squeezing strength curve.

Returning to FIG. 2, the display 140 is coupled to the processor 110 and configured to display a desktop of an operating system of the mobile device 1, a played content, or other visual information. In this embodiment, the display 140 may be a liquid-crystal display (LCD), a light-emitting diode (LED) display, or a field emission display (FED). The display 140 may also be a touch screen composed of a display panel of other types and a touch panel (e.g., a resistive type touch panel, a capacitive touch panel or an optical touch panel) which is capable of providing touch and display operating functions at the same time, or may be other displays for providing the display function, which are not particularly limited in the invention.

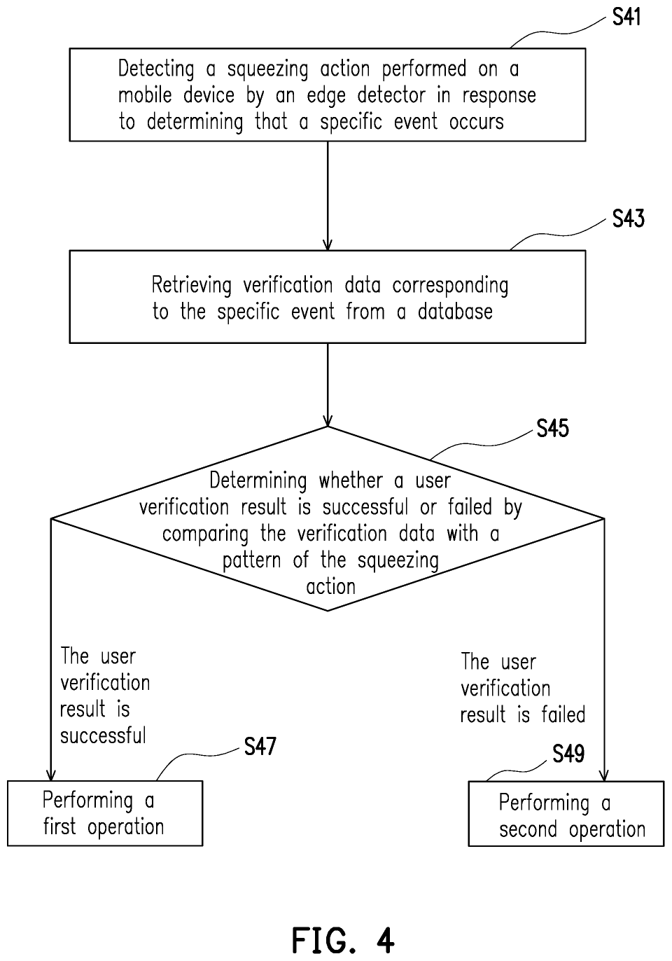

FIG. 4 is a flowchart illustrating a user verification method according to the first embodiment of the invention. Referring to FIG. 4, in step S41, a squeezing action performed on the mobile device 1 is detected by the edge detector 130 in response to determining that a specific event occurs. Specifically, in this embodiment, the specific event can include, but not limited to, one or a combination of events (1) to (6) listed below.

Event (1): an incoming call received by the mobile device 1. For example, when the mobile device 1 receives a call made by another mobile device, the processor 110 determines that the specific event occurs.

Event (2): a camera shutter operation received by the mobile device 1. For example, when the mobile device 1 detects that a button corresponding to a camera shutter is triggered/pressed, the processor 110 can determine that the mobile device 1 is receiving the camera shutter operation.

Event (3): a notification received by the mobile device 1. For example, an application installed in the mobile device 1 sends the notification to the user in response to a received message; or a function of the mobile device 1 itself or the installed application sends the notification to the user under certain conditions, such as an alarm clock. The notification may include one or a combination of a sound notification, an image notification, and a text notification.

Event (4): a predetermined program of the mobile device being performed. For example, the user triggers the function of the application installed on the mobile device (e.g., the function corresponding to “Telephone” application; the function corresponding to “Camera” application) by operation modes like tapping/pressing/touching or squeezing; or the function of the mobile device itself (e.g., turning on/off the display, shutdown, restarting, screenshot, photographic shutter, volume control and settings of the mobile device operating system) is triggered by the above operation modes.

Event (5): an unlocking operation performed on the mobile devices. For example, the mobile device 1 is triggered to perform the unlocking operation.

Event (6): a transition of the mobile device 1 from a stationary state (e.g., being left idle for a period of time) to a held state. For example, the processor 110 can detect whether a posture of the mobile device 1 is changed from the stationary state to the held state by the detector of the mobile device 1, such as an accelerometer. When the processor 110 determines that the mobile device 1 is transitioning from the stationary state to the held state (or when it is picked up in the stationary state), the processor 110 determines that the specific event occurs. The invention is not limited to the manner in which the processor 110 determines that the mobile device 1 is transitioning from the stationary state to the held state, and different determinations or detections may be made for different manners.

In response to the specific event that occurs, the processor 110 instructs the edge detector 130 to start detecting the squeezing action applied/performed on the mobile device 1 and performs a verification procedure based on the detected squeezing action to obtain a user verification result. Accordingly, whether the user currently holding the mobile device 1 is the specific user can be verified.

Next, in step S43, the processor 110 retrieves verification data corresponding to the specific event from the database 121.

Specifically, the database 121 can store the verification data corresponding to a plurality of different specific events.

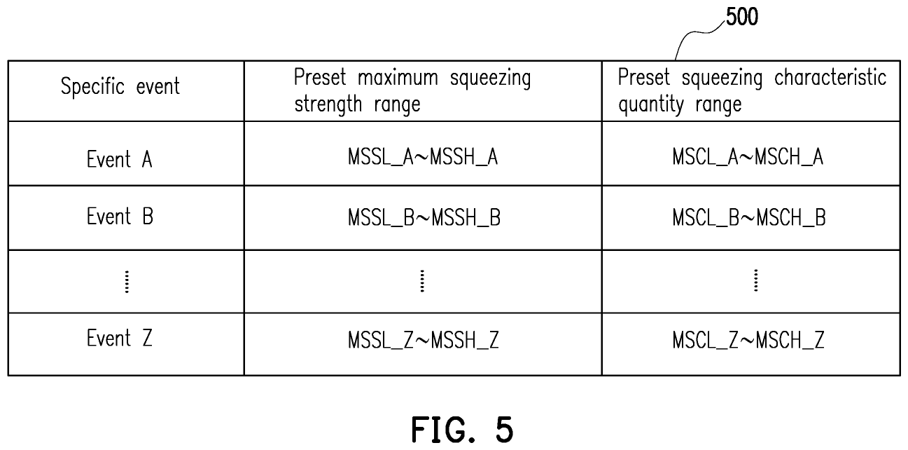

FIG. 5 is a schematic diagram illustrating a plurality of verification data corresponding to a plurality of different specific events according to the first embodiment of the invention. Referring to FIG. 5, in this embodiment, verification data 500 may include a plurality of preset maximum squeezing strength value ranges and a plurality of preset squeezing characteristic quantity ranges respectively corresponding to the specific events (e.g., Events A, B to Z). For example, the verification data 500 may record a preset maximum squeezing strength range MSSL_A to MSSH_A and a preset squeezing characteristic quantity range MSCL_A to MSCH_A corresponding to Event A. Among them, MSSH_A and MSSL_A are squeezing strength values greater than zero and respectively used to indicate upper and lower boundaries of the preset maximum squeezing strength value range corresponding to Event A, and MSCH_A and MSCL_A are squeezing characteristic quantities greater than zero and respectively used to indicate upper and lower boundaries of the preset squeezing characteristic quantity range corresponding to Event A.

More specifically, by receiving the squeezing action corresponding to the specific event performed by the specific user, the processor 110 can obtain a plurality of maximum squeezing strength values of the specific user respectively corresponding to a plurality of squeezing actions of the specific event. Next, the processor 110 calculates the maximum squeezing strength value range according to a preset percentage and the maximum squeezing strength values. In an embodiment, a size of the preset percentage may be determined by a statistical method. For example, assuming that the preset percentage is 10% and the maximum squeezing strength value is 100 units, a calculated preset maximum squeezing strength range is 90 (i.e., 100−100×10%) to 110 (i.e., 100+100×10%) units. In another embodiment, the processor 110 can continuously collect the maximum squeezing strength values of the squeezing action of the specific user when the specific event occurs for a certain period of time (e.g., one week) in daily life, and estimate the preset maximum squeezing strength range according to the maximum squeezing strength values collected at different times. In this way, the estimated maximum squeezing strength value range can contain as much as possible all the possible maximum squeezing strength values corresponding to the same specific event.

Next, in step S45, the processor 110 determines whether the user verification result is successful or failed by comparing the verification data with a pattern of the squeezing action. Specifically, the processor 110 can obtain the strength of the squeezing action (i.e., the squeezing strength value) according to the squeezing action detected by the edge detector 130, and verify whether the user holding the mobile device 1 is the specific user when the current specific event occurs by comparing the obtained squeezing strength values with the verification data. That is, the processor 110 performs the verification procedure according to the squeezing action to determine whether the user verification result is successful or failed.

More specifically, in response to the squeezing action being detected, the edge detector continuously outputs the squeezing strength values to the processor 110 over time. During a first predetermined time after the squeezing action is detected, the processor 110 records a plurality of squeezing strength values of the squeezing action over time to obtain the squeezing strength curve corresponding to the squeezing action. Here, the squeezing strength curve is configured to indicate the squeezing strength values of the squeezing action detected at different time points within the first predetermined time.

Next, the processor 110 can identify the maximum squeezing strength value in the squeezing strength values according to the squeezing strength curve. For instance, in this embodiment, the processor 110 can identify a rising region appeared first in the squeezing strength curve (this rising region reflects an initial force of the squeezing action). All the squeezing strength values in the rising region in the squeezing strength curve are greater than an initial threshold (e.g., 0 or the squeezing threshold described above). Next, the processor 110 can identify a largest squeezing strength value in all the squeezing strength values in the rising region as the maximum squeezing strength value. Briefly, after the rising region of the squeezing strength curve is determined, the processor 110 can start looking for the maximum squeezing strength value.

After the maximum squeezing strength value is identified, the processor 110 can compare the identified maximum squeezing strength value with the preset maximum squeezing strength range in the verification data to determine whether the maximum squeezing strength value is within the preset maximum squeezing strength range. In response to determining that the maximum squeezing strength value is within the preset maximum squeezing strength range, the processor 110 determines that the user verification result is successful. Next, in step S47, the processor 110 performs a first operation. In other words, when the user verification result is determined as successful, the processor 110 determines that the user currently holding the mobile device 1 matches the specific user, and correspondingly allows the first operation corresponding to the specific event that occurs to be performed.

In this embodiment, the first operation described above substantially corresponds to the specific event that occurs. For example, the first operation described above includes, but not limited to, one or a combination of the following operations: (1) unlocking the mobile device; (2) taking a photo or making a video, that is, performing the function after the camera shutter is triggered; (3) turning on a display/a display screen of the mobile device; (4) answering an incoming call corresponding to the specific event; (5) displaying a notification corresponding to the specific event; (6) performing a predetermined program corresponding to the specific event; and (7) performing a function of the mobile device corresponding to the specific event.

Conversely, in response to determining that the maximum squeezing strength value is not within the preset squeezing strength range, the processor 110 determines that the user verification result is failed. Next, the processor 110 performs a second operation.

In this embodiment, in response to the user verification result being failed, the method proceeds to step S49 in which the processor 10 performs the second operation. In an embodiment, the second operation includes locking the mobile device 1. That is, when the user verification result is determined as failed, the processor 110 determines that the user currently holding the mobile device 1 is not the specific user, and correspondingly takes security measures. The security measures may include, for example, locking the mobile device, shutting down the mobile device 1, disabling the mobile device from performing any operation for a period of time, keeping the screen of the mobile device turned off and disallowing the mobile device to perform any operation or other suitable security measures corresponding to Illegal users. The invention is not limited in this regard. It should be noted that, in another embodiment, the second operation further includes displaying a password input interface. The user can enter a password for unlocking the mobile device through the password input interface.

In yet another embodiment, the second operation further includes sending a warning notification to a registered user of the mobile device. The registered user may be the specific user of the mobile device or other registered users who can receive the warning notification. The warning notification is, for example, a notification transmitted via a text message, a telephone, an instant message, or an email in the background, indicating that the mobile device 1 is suspected to be held by a user other than the specific user. In addition, the warning notification may further include location information of the mobile device 1, such as information indicating a location or contact information of the mobile device 1 obtained by a GPS device or a communication device of the mobile device 1. In an embodiment, the mobile device can simultaneously use both operations of taking the security measures and sending the warning notification as the second operation.

In another embodiment, in response to the user verification result determined as being failed, the processor 110 still performs the first operation and then performs the second operation after the first operation is performed.

It is worth mentioning that, in still another embodiment, in response to determining that the maximum squeezing strength value is not within the preset squeeze strength range, the processor 110 does not directly determine that the user verification result is failed, but further performs another step to determine whether the user verification result is successful or failed. Specifically, in response to determining that the identified maximum squeezing strength value is not within the preset squeeze feature amount, the processor 110 does not perform the second operation first. Instead, the processor 110 further retrieves the preset squeezing characteristic quantity range corresponding to the specific event in verification data 700 from the database 121 according to the currently occurring specific event, and tries to compare a squeezing characteristic quantity of the detected squeezing action with the preset squeezing characteristic quantity range.

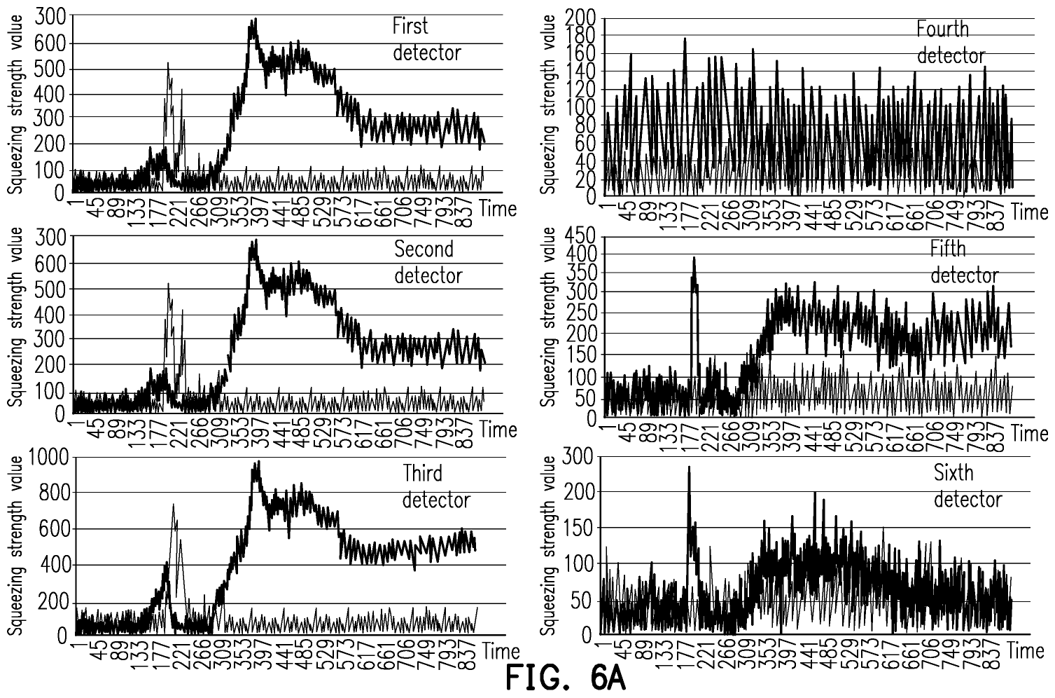

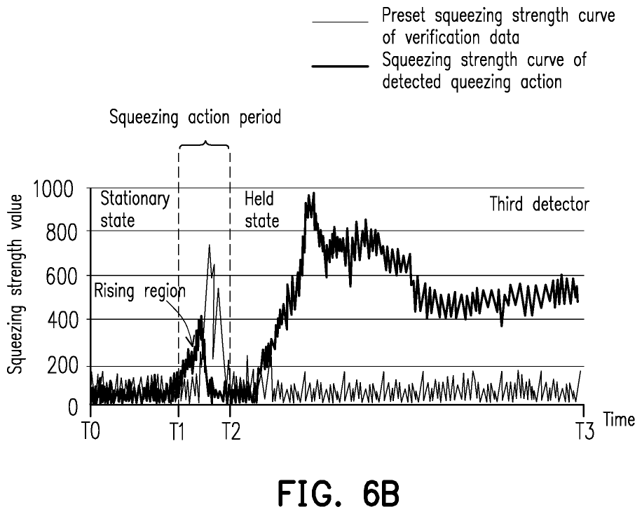

More specifically, in this embodiment, in response to the maximum squeezing strength value not within the preset squeezing strength range, the processor 110 can calculate the squeezing characteristic quantity according to the identified maximum squeezing strength value, and compare the squeezing characteristic quantity with the preset squeezing characteristic quantity range. In this embodiment, according to the squeezing strength curve located in a rising region, the processor 110 can perform an integral operation on the squeezing strength values with time to obtain an integral value, and use the integral value as the squeezing characteristic quantity. Briefly, the processor 110 calculates an area enclosed by the squeezing strength curve located in the rising region and a horizontal coordinate axis (assuming that the squeezing strength curve is plotted in a line chart with a horizontal coordinate axis as time and a vertical coordinate axis as the squeezing strength value). However, the invention is not limited in this regard. The processor 110 can use other methods to calculate the squeezing characteristic quantity according to the maximum squeezing strength value or the rising region. For example, in another embodiment, according to the squeezing strength curve located in the rising region, the processor 110 performs a root mean square operation on all the squeezing strength values in the rising region, and uses an obtained result as the squeezing characteristic quantity. It should be noted that a setting manner (or obtaining manner) of the preset squeezing characteristic quantity range is similar to that of the preset squeezing strength range (e.g., recording the squeezing strength curve by receiving the squeezing action performed on the mobile device by the specific user corresponding to the specific event or recording the squeezing action performed by the specific user when the specific event occurs in daily life, so as to obtain the squeezing characteristic quantity according to the squeezing strength curve). The difference is that the step of “calculating/obtaining/recording the maximum squeezing strength value of the squeezing action of the specific user corresponding to the specific event” is changed to “calculating/acquiring/recording the squeezing characteristic quantity of the squeezing action of the specific user corresponding to the specific event”. Detailed description regarding the same is provided below with reference to FIG. 6A and FIG. 6B.

Next, in response to the calculated squeezing characteristic quantity within the preset squeezing characteristic quantity range, the processor 110 determines that the user verification result is successful and does not determine that the user verification result is failed. Conversely, in response to determining that the squeezing characteristic quantity not within the preset squeezing characteristic quantity range, the processor 110 determines that the user verification result is failed. Next, the processor 110, as described above, performs the first operation or the second operation in correspondence to the user verification result being successful or failed.

FIG. 6A illustrates line charts of a plurality of squeezing strength curves respectively corresponding to a plurality of edge detectors according to the first embodiment of the invention. Referring to FIG. 6A, in this embodiment, the verification data corresponding to the specific event may also include a plurality of preset squeezing strength curves corresponding to the different edge detectors 130(1) to 130(6). It is assumed that the squeezing strength curves respectively corresponding to the first to sixth detectors 130(1) to 130(6) are as shown in FIG. 6A. Here, the preset squeezing strength curves respectively corresponding to the verification data of the first to sixth detectors are thicker curves. In addition, it is assumed that a plurality of squeezing strength curves of the squeezing actions currently detected by the first to sixth detectors 130(1) to 130(6) respectively corresponding to the specific event that occurs are as shown by thinner curves in the line charts. For a detector, the processor 110 can compare the squeezing strength curve corresponding to the detected squeezing action with the preset squeezing strength curve corresponding to the detector in the line chart, so as to perform the verification procedure through the squeezing action detected by the detector. In other words, the above operation may be used to obtain a detector verification result for each of the detectors by performing the corresponding verification procedure on each of the detectors.

FIG. 6B illustrates a line chart of a squeezing strength curve of the squeezing action detected by one edge detector according to the first embodiment of the invention. Referring to FIG. 6B (e.g., the line chart of the squeezing strength curve of the third detector), for example, in view of the squeezing strength curve corresponding to the specific event (the thicker curve), the mobile device 1 is initially determined as in the stationary state (e.g., time points T0 to T1). Next, the processor 110 determines that the specific event occurs (picking up from the stationary state). The user performs the squeezing action on the mobile device 1 to pick up the mobile device, and the squeezing strength curve starts to rise (i.e., the rising region) in this period (e.g., time points T1 to T2) (i.e., a squeezing action period). In this squeezing action period, the processor 110 can determine that the highest point of the squeezing strength curve during this period is the maximum squeezing strength value (e.g., 400). In addition, in this squeezing action period, the processor 110 can determine that the highest point of the preset squeezing strength curve (the thinner curve) during the period is the preset maximum squeezing strength value (e.g., 800), and the corresponding squeezing strength range is 720 to 880. It should be noted that, a period from time points T2 to T3 is a period during which the mobile device is being held.

In the verification procedure described above, according to the squeezing action detected by the third detector, the maximum squeezing strength value is not within the preset squeezing strength range. Based on this, the processor 110 can directly determine that the verification result corresponding to the third detector (i.e., a third detector verification result) is failed. Alternatively, the processor 110, as described above, calculates the squeezing characteristic quantity (e.g., calculates the area enclosed by the squeezing strength curve located in the rising region and the horizontal coordinate axis) to be compared with the preset squeezing characteristic quantity range for further verification.

It should be noted that, for each of the squeezing strength curves of the squeezing actions detected by the detector, the processor 110 can perform the verification procedure to obtain a corresponding verification result for each one of the detectors. In this embodiment, in the case where multiple detectors are provided, only when all the verification results of the detectors are successful (or when the verification results of a certain ratio or a certain number of the detectors are successful), the processor 110 then determines that the user verification result is successful, and shows that the user currently performing the squeezing action is the specific user. For example, in an embodiment, when a total of the detectors with the verification results being successful is greater than a predetermined threshold, the processor performs the first operation; otherwise, when the total of the detectors with the verification results being successful is greater than the predetermined threshold, the processor performs the second operation. The predetermined threshold may be predetermined by the system or may be set by the user, and may be less than or equal to a total of all the detectors.

Other verification procedures using the squeezing strength curve will be explained below with reference to the second embodiment. The corresponding component numbers and functions of the hardware of the second embodiment are the same as those of the first embodiment, which are not repeated herein.

### Second Embodiment

Compared with the first embodiment, in the second embodiment, for the squeezing action detected with respect to the specific event that occurs, the processor 110 converts an analog squeezing strength value (the squeezing strength curve) detected by each of the detectors into a digital squeezing strength code, and compares a plurality of squeezing strength codes respectively corresponding to a plurality of detectors with a password corresponding to the specific event to obtain a user verification result for determining whether the user is the specific user.

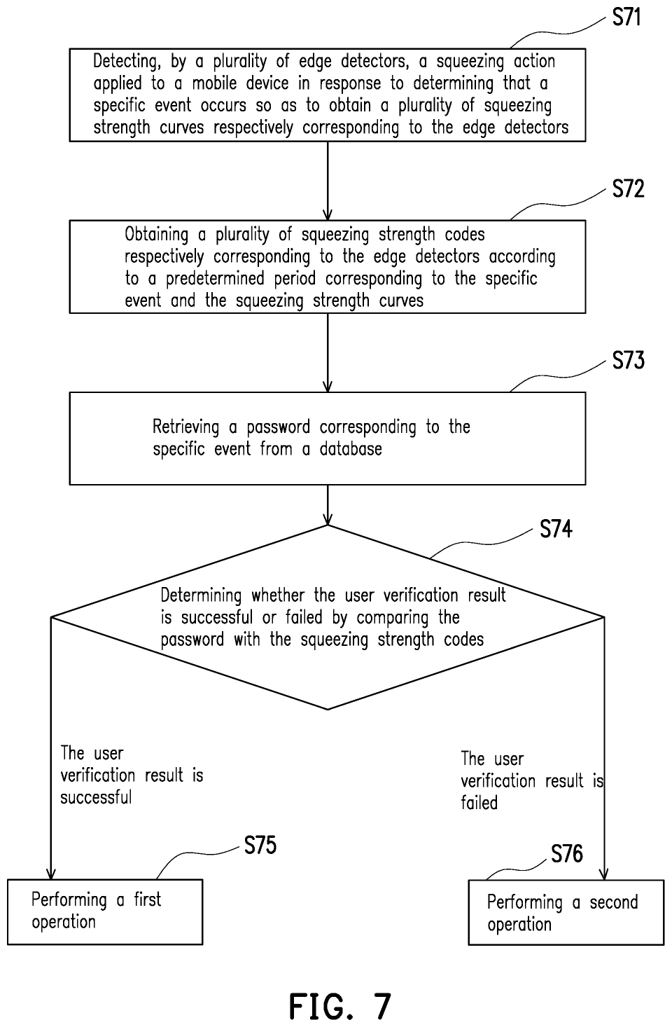

FIG. 7 is a flowchart illustrating a verification method according to a second embodiment of the invention. Referring to FIG. 7, in step S71, when determining that a specific event occurs, the processor 110 detects a squeezing action applied to the mobile device by a plurality of edge detectors of the device so as to obtain a plurality of squeezing strength curves respectively corresponding to the edge detectors (e.g., the squeezing strength curves respectively corresponding to the first to sixth detectors shown in FIG. 6).

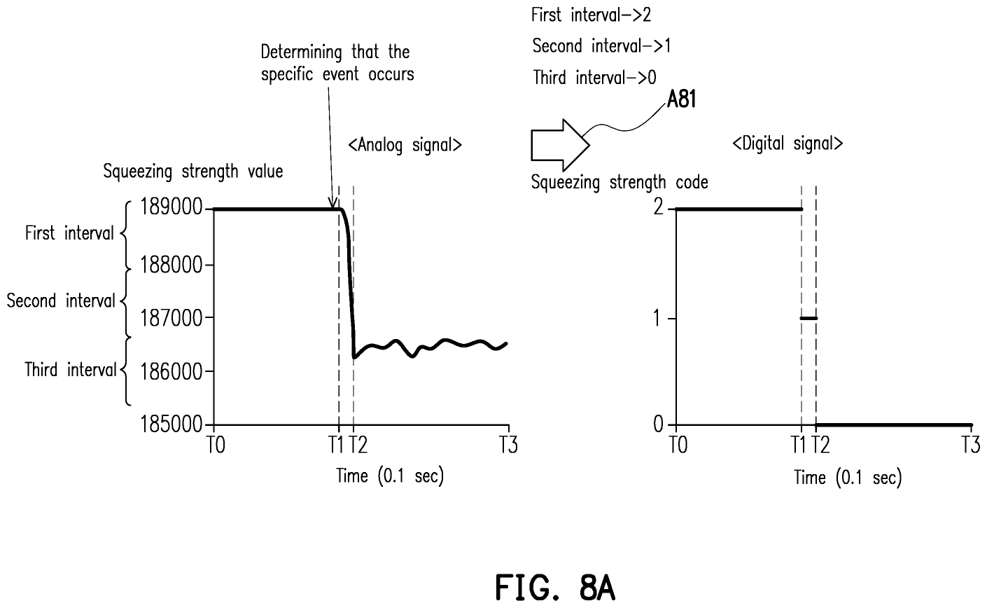

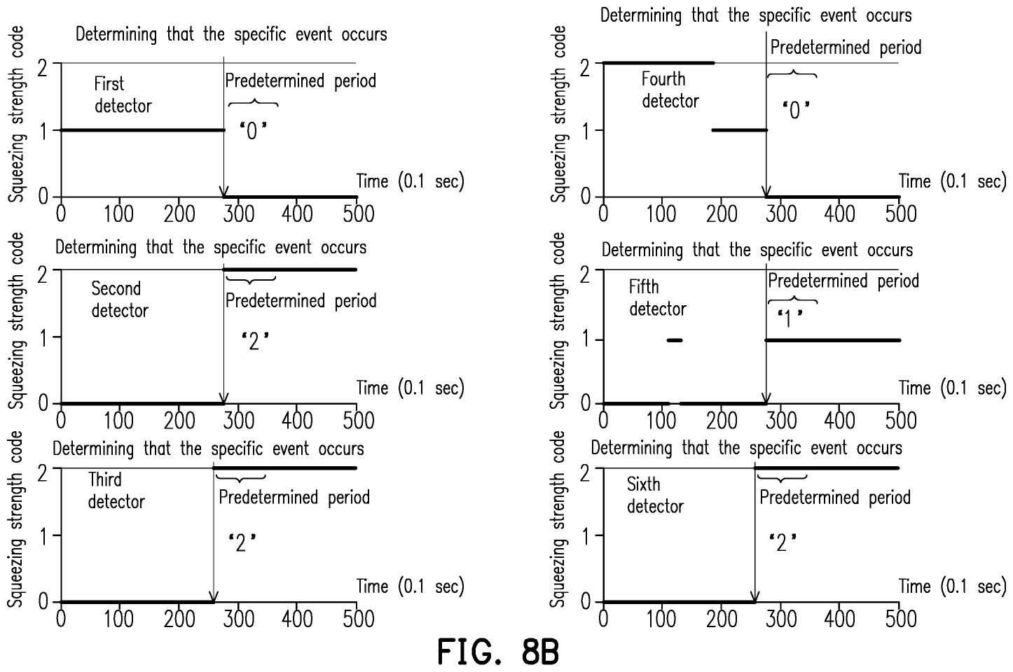

In step S72, a plurality of squeezing strength codes respectively corresponding to the edge detectors are obtained according to a predetermined period corresponding to the specific event and the squeezing strength curves. Details for converting the squeezing strength values into the squeezing strength codes are described below with reference to FIG. 8A.

FIG. 8A is a schematic diagram illustrating how the squeezing strength values are converted into the squeezing strength codes according to the second embodiment of the invention. Referring to FIG. 8A, for instance, it is assumed that a squeezing strength curve of a squeezing action detected by a detector is provided on the left side of FIG. 8A, and is formed by the analog squeezing strength values detected at different time points. In a converting procedure, according to magnitudes of a plurality of squeezing strength values (a.k.a. first squeezing strength values) recorded by a squeezing strength curve (a.k.a. a first squeezing strength curve), the processor 110 divides the first squeezing strength values into a plurality of intervals. Here, a total number of the intervals can be set according to a security strength of the verification procedure. For example, if the security strength is required to be higher, the total number of the intervals may be increased, and each of the intervals has the corresponding squeezing strength code.

For instance, as shown in FIG. 8A, according to vertical distribution regions of the squeezing strength curve, the processor 110 divides the squeezing strength curve into three intervals (e.g., first to third intervals). The first interval has the squeezing strength code “2”; the second interval has the squeezing strength code “1”; the third interval has the squeezing strength code “0”. In other words, the processor 110 converts the squeezing strength values of the squeezing strength curve located in the different sections into the squeezing strength codes of the regions to which the respective squeezing strength values are located, as indicated by an arrow A81. Then, the squeezing strength codes (a.k.a. first squeezing strength codes) at different time points may be obtained, and accordingly, a digital squeezing strength code chart as shown by the left side of FIG. 8A may be obtained.

For example, between the time points T0 and T1, because the squeezing strength curve is located within the first interval, the squeezing strength values within this interval are converted into the squeezing strength code “2”; between the time points T1 and T2 (i.e., the predetermined period), because the squeezing strength curve is located within the second interval, the squeezing strength values within this interval are converted into the squeezing strength code “1”; between the time points T2 and T3, because the squeezing strength curve is located within the third interval, the squeezing strength values within this interval are converted into the squeezing strength code “0”. The predetermined period is a period of time (e.g., 2 seconds) after the specific event occurs. It should be noted that, a length of the predetermined period is not limited by the invention.

FIG. 8B is a schematic diagram illustrating the converted squeezing strength codes respectively corresponding to a plurality of edge detectors according to the second embodiment of the invention. For instance, referring to FIG. 8B, after the squeezing strength curves corresponding to the detectors are all converted, a plurality of converted squeezing strength code charts respectively corresponding to the detectors may be obtained, as shown by FIG. 8B.

Next, the processor 110 identifies a second squeezing strength code located within the predetermined period, and uses the second squeezing strength code as the squeezing strength code corresponding to the first edge detector. For instance, in the squeezing strength code charts corresponding to the first to sixth detectors, the second squeezing strength codes are “0”, “2”, “2”, “0”, “1” and “2”, respectively. That is, the squeezing strength codes respectively corresponding to the first to sixth detectors obtained by the processor 110 are “0, 2, 2, 0, 1 and 2”.

After the squeezing strength codes respectively corresponding to the detectors are obtained, in step S73, the processor 110 retrieves a password corresponding to the specific event from the database 121.

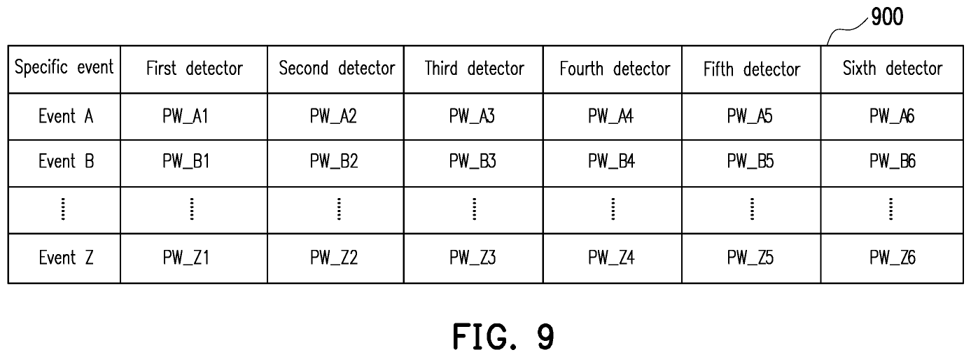

FIG. 9 is a schematic diagram illustrating a plurality of passwords corresponding to a plurality of different specific events according to the second embodiment of the invention. Referring to FIG. 9, the database 121 can store a plurality of passwords respectively corresponding to a plurality of specific events, and each of the passwords records a plurality of codewords (Unicode) respectively corresponding to the different detectors. For example, in this embodiment, the password corresponding to Event A records codewords PW_A1, PW_A2, PW_A3, PW_A4, PW_A5 and PW_A6 respectively corresponding to the first to sixth detectors; the password corresponding to Event B records codewords PW_B1, PW_B2, PW_B3, PW_B4, PW_B5 and PW_B6 respectively corresponding to the first to sixth detectors; . . . the password corresponding to Event Z records codewords PW_Z1, PW_Z2, PW_Z3, PW_Z4, PW_Z5 and PW_Z6 respectively corresponding to the first to sixth detectors. Here, for descriptive convenience, it is assumed that the specific event is Event A, and thus the password retrieved by the processor 110 is “PW_A1, PW_A2, PW_A3, PW_A4, PW_A5 and PW_A6”.

Next, in step S74, the processor 110 determines whether the user verification result is successful or failed by comparing the password with the squeezing strength codes.

Specifically, the processor 110 identifies the codewords respectively corresponding to the edge detectors in the password. In addition, the processor 110 also obtains the squeezing strength codes respectively corresponding to the detectors in step S72. That is to say, the codewords may respectively correspond to the squeezing strength codes by being associated with the detectors. Next, the processor 110 can determine whether the squeezing strength codes match the corresponding codewords based on the detectors.

In this embodiment, the user verification result is determined as failed in response to a number of the squeezing strength codes of the detectors determined as mismatching the corresponding codewords greater than or equal to a predetermined number. The user verification result is determined as successful in response to the number of the squeezing strength codes determined as mismatching the corresponding codewords less than the predetermined number. The predetermined number is, for example, set to a difference obtained by subtracting the predetermine threshold from the total of all the detectors.

For instance, it is assumed that the predetermined number is 2, and values of the password “PW_A1, PW_A2, PW_A3, PW_A4, PW_A5 and PW_A6” retrieved by the processor 110 are “0, 2, 2, 0, 1 and 1”, respectively. Then, the processor 110 compares the above values with the obtained squeezing strength codes “0, 2, 2, 0, 1 and 2”, respectively. In this example, the processor 110 determines that only the squeezing strength code “2” corresponding to the sixth detector mismatches the codeword PW_A6. In other words, there is only one squeezing strength code determined as mismatching the corresponding codeword. That is, the number of the squeezing strength codes determined as mismatching the corresponding codewords is less than the predetermined number 2. In this example, the processor 110 determines that the user verification result is successful. Next, in response to the user verification result being successful, the method proceeds to step S75, in which the processor 110 performs the first operation.

As another example, it is assumed that the predetermined number is 2, and values of the password “PW_A1, PW_A2, PW_A3, PW_A4, PW_A5 and PW_A6” retrieved by the processor 110 are “0, 2, 2, 0, 0 and 1”, respectively. Then, the processor 110 compares the above values with the obtained squeezing strength codes “0, 2, 2, 0, 1 and 2”, respectively. In this example, the processor 110 determines that the squeezing strength code “1” corresponding to the fifth detector mismatches “0” of the codeword PW_A5 and the squeezing strength code “2” corresponding to the sixth detector mismatches “1” of the codeword PW_A6. That is, there are two of the squeezing strength codes determined as mismatching the corresponding codewords, which indicates that the number of the squeezing strength codes determined as mismatching the corresponding codewords reaches the predetermined number 2. In this example, the processor 110 determines that the user verification result is failed. Next, in response to the user verification result being failed, the method proceeds to step S77, in which the processor 110 performs the second operation.

In an embodiment, the predetermined number may be set according to the security strength. The lower the security strength, the higher the predetermined number will be used. In another embodiment, a predetermined number of matches may also be set, and the user verification result is determined as successful only when the predetermined number of matches is reached, and is otherwise determined as failed.

In summary, the user verification method and the mobile device provided in the foregoing embodiments of the invention can detect, by the edge sensor, the squeezing action performed on the mobile device in response to determining that the specific event occurs, and compares the squeezing strength value or the squeezing characteristic quantity of the squeezing action with the verification data so as to determine whether the user verification result is successful or failed. In addition, the squeezing strength codes respectively corresponding to the edge detectors may also be obtained from the detected squeezing action, so as to determine whether the user verification result is successful or failed by comparing the password corresponding to the event with the squeezing strength codes. Finally, whether to perform the first operation or the second operation corresponding to the specific event may be determined according to the user verification result.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A user verification method adapted for a mobile device having an edge detector, the method comprising:
in response to determining that a specific event occurs, detecting a squeezing action performed on the mobile device by the edge detector;
performing a verification procedure according to the squeezing action to obtain a user verification result;
in response to the user verification result being successful, performing a first operation; and
in response to the user verification result being failed, performing a second operation;
wherein the second operation comprises locking the mobile device,
wherein the verification procedure comprises:
retrieving verification data corresponding to the specific event from a database; and
determining whether the user verification result is successful or failed by comparing the verification data with a pattern of the squeezing action.

2. The method according to claim 1, wherein the verification data comprises a preset squeezing strength range corresponding to the specific event, wherein the step of determining whether the user verification result is successful or failed by comparing the verification data with the pattern of the squeezing action comprises:
in response to the squeezing action being detected, obtaining a squeezing strength curve corresponding to the squeezing action recorded within a first predetermined time, wherein the squeezing strength curve is configured to indicate a plurality of squeezing strength values of the squeezing action detected at different time points within the first predetermined time;
identifying a maximum squeezing strength value in the squeezing strength values according to the squeezing strength curve;
determining whether the maximum squeezing strength value is within the preset squeezing strength range;
in response to determining that the maximum squeezing strength value is within the preset squeezing strength range, determining that the user verification result is successful; and
in response to determining that the maximum squeezing strength value is not within the preset squeezing strength range, determining that the user verification result is failed.

3. The method according to claim 2, wherein the step of identifying the maximum squeezing strength value in the squeezing strength values according to the squeezing strength curve comprises:
identifying a rising region appeared first in the squeezing strength curve, wherein all the squeezing strength values in the rising region are greater than an initial threshold; and
identifying a largest squeezing strength value in all the squeezing strength values in the rising region as the maximum squeezing strength value.

4. The method according to claim 1, wherein the verification data comprises a preset squeezing characteristic quantity range corresponding to the specific event, wherein the step of determining whether the user verification result is successful or failed by comparing the verification data with the pattern of the squeezing action comprises:
in response to the squeezing action being detected, obtaining a squeezing strength curve corresponding to the squeezing action recorded within a first predetermined time, wherein the squeezing strength curve is configured to indicate a plurality of squeezing strength values of the squeezing action detected at different time points within the first predetermined time;
identifying a maximum squeezing strength value in the squeezing strength values according to the squeezing strength curve;
in response to determining that the maximum squeezing strength value is not within the preset squeezing strength range, calculating a squeezing characteristic quantity according to the maximum squeezing strength value, and comparing the squeezing characteristic quantity with the preset squeezing characteristic quantity range;
in response to determining that the squeezing characteristic quantity is not within the preset squeezing characteristic quantity range, determining that the user verification result is failed; and
in response to determining that the squeezing characteristic quantity is within the preset squeezing characteristic quantity range, determining that the user verification result is successful.

5. The method according to claim 4, wherein the step of calculating the squeezing characteristic quantity according to the maximum squeezing strength value comprises:
according to the squeezing strength curve of the rising region, performing an integral operation on the squeezing strength values with time to obtain an integral value, and using the integral value as the squeezing characteristic quantity.

6. The method according to claim 4, wherein the step of calculating the squeezing characteristic quantity according to the maximum squeezing strength value comprises:
according to the squeezing strength curve of the rising region, performing a root mean square operation on all the squeezing strength values in the rising region to obtain the squeezing characteristic quantity.

7. The method according to claim 1, wherein the specific event comprises:
an incoming call received by the mobile device;
a camera shutter operation received by the mobile device;
a notification received by the mobile device;
a predetermined program of the mobile device being performed,
an unlocking operation performed on the mobile devices; or
a transition of the mobile device from a stationary state to a held state being determined.

8. The method according to claim 1, wherein the step of performing the first operation comprises one or a combination of the following steps:
unlocking the mobile device;
taking a photo;
turning on a display screen of the mobile device;
answering an incoming call corresponding to the specific event;
displaying a notification corresponding to the specific event;
performing a predetermined program corresponding to the specific event; and
performing a function of the mobile device corresponding to the specific event.

9. The method according to claim 1, wherein the second operation further comprises sending a warning notification to a registered user of the mobile device.

10. The method according to claim 1, wherein the second operation further comprises displaying a password input interface.

11. The method according to claim 1, wherein the edge detector comprises a plurality of detectors,
wherein the step of detecting, by the edge detector, the squeezing action performed on the mobile device comprises: detecting, by the detectors, a plurality of squeezing actions performed on the mobile device respectively;
wherein the step of performing the verification procedure according to the squeezing action to obtain the user verification result comprises: performing the verification procedure to obtain a detector verification result by each of the detectors;
wherein in response to the user verification result being successful, the step of performing the first operation comprises: in response to a total of successful detector verification results in the detector verification results of the squeezing actions detected by the detectors being greater than a predetermined threshold, performing the first operation;
wherein in response to the user verification result being failed, the step of performing the second operation comprises: in response to the total of successful detector verification results in the detector verification results of the squeezing actions detected by the detectors not being greater than the predetermined threshold, performing the second operation.

12. The method according to claim 1, wherein in response to the user verification result being failed, the step of performing the second operation further comprises:
performing the first operations.

13. A user verification method adapted for a mobile device having a plurality of edge detectors, the user verification method comprising:
detecting, by the edge detectors, a squeezing action applied to the mobile device in response to determining that a specific event occurs so as to obtain a plurality of squeezing strength curves respectively corresponding to the edge detectors, wherein each of the squeezing strength curves records a plurality of squeezing strength values of the squeezing action sequentially detected at different time points by the respective edge detector to which each of the squeezing strength curves belongs;
obtaining a plurality of squeezing strength codes respectively corresponding to the edge detectors according to a predetermined period corresponding to the specific event and the squeezing strength curves;
performing a verification procedure according to the squeezing strength codes to obtain a user verification result;
in response to the user verification result being successful, performing a first operation;
in response to the user verification result being failed, performing a second operation;
wherein the second operation comprises locking the mobile device,
wherein the verification procedure comprises:
retrieving a password corresponding to the specific event from a database; and
determining whether the user verification result is successful or failed by comparing the password with the squeezing strength codes.

14. The method according to claim 13, wherein the squeezing strength curves comprises a first squeezing strength curve, wherein the first squeezing strength curve corresponds to a first edge detector in the edge detectors, wherein the step of obtaining the squeezing strength codes respectively corresponding to the edge detectors according to the predetermined period corresponding to the specific event and the squeezing strength curves comprises:
according to magnitudes of a plurality of first squeezing strength values recorded by the first squeezing strength curve, dividing the first squeezing strength values into a plurality of intervals, wherein each of the intervals has the corresponding squeezing strength code;
converting the first squeezing strength values into the squeezing strength codes of the interval to which the first squeezing strength values belong, so as to obtain a plurality of first squeezing strength codes respectively corresponding to the first squeezing strength values; and
identifying a second squeezing strength code located within the predetermined period in the first squeezing strength codes, and using the second squeezing strength code as the squeezing strength code corresponding to the first edge detector.

15. The method according to claim 14, wherein the step of determining whether the user verification result is successful or failed by comparing the password with the squeezing strength codes comprises:
identifying a plurality of codewords respectively corresponding to the edge detectors in the password, wherein the codewords respectively correspond to the squeezing strength codes;
determining whether the squeezing strength codes match the corresponding codewords based on the edge detectors,
wherein the user verification result is determined as failed in response to a number of the squeezing strength codes determined as mismatching the corresponding codewords greater than or equal to a predetermined number,
wherein the user verification result is determined as successful in response to the number of the squeezing strength codes determined as mismatching the corresponding codewords less than the predetermined number.

16. The method according to claim 13, wherein the specific event comprises:
an incoming call received by the mobile device;
a camera shutter operation received by the mobile device;
a notification received by the mobile device;
a predetermined program of the mobile device being performed,
an unlocking operation performed on the mobile devices; or
a transition of the mobile device from a stationary state to a held state being determined.

17. The method according to claim 13, wherein the step of performing the first operation comprises one or a combination of the following steps:
unlocking the mobile device;
taking a photo;
turning on a display screen of the mobile device;
answering an incoming call corresponding to the specific event;
displaying a notification corresponding to the specific event;
performing a predetermined program corresponding to the specific event; and
performing a function of the mobile device corresponding to the specific event.

18. The method according to claim 13, wherein the second operation further comprises sending a warning notification to a registered user of the mobile device.

19. A mobile device, comprising:
a body, wherein a processor is disposed in the body;
an edge detector disposed on two sides of the body;
a storage device; and
a processor coupled to the edge detector and the storage device,
wherein the processor is configured to instruct the edge detector to detect a squeezing action applied to the body in response to determining that a specific event occurs, and the processor is configured to perform a verification procedure according to the squeezing action to obtain a user verification result,
wherein in response to the user verification result being successful, the processor is configured to perform a first operation,
wherein in response to the user verification result being failed, the processor is configured to perform a second operation, wherein the second operation comprises locking the mobile device,
wherein the verification procedure comprises:
retrieving verification data corresponding to the specific event from a database in the storage device by the processor; and
determining whether the user verification result is successful or failed by comparing the verification data with a pattern of the squeezing action by the processor.
